(19) United States
(12) Patent Application Publication
(10) Pub. No.: US 2006/0190944 A1
(43) Pub. Date: Aug. 24, 2006

(54) System and Method for Resource Management

(76) Inventors: Charles Moon, Round Rock, TX (US); Michael Zrubek, Granger, TX (US)

Correspondence Address: TAYLOR RUSSELL & RUSSELL, P.C., 4807 SPICEWOOD SPRINGS ROAD, BUILDING TWO SUITE 250, AUSTIN, TX, 78759, US

(21) Appl. No.: 10/906,416

(22) Filed: Feb. 18, 2005

(51) Int. Cl. G06F 9/46

(52) U.S. Cl. 718/104

(57) ABSTRACT

The resource management system and method is a solution for balancing or leveling resource utilization in business processes. The solution relies on an analysis model implemented on a computer system with a user interface. A user enters resource capability data, resource requirements data including prioritized tasks and task categories, and a time period for providing dynamic allocation of resources to prioritized tasks within prioritized task categories. The invention makes use of categorization data for analyzing and altering the data within the defined time range or other specified data selection. Using a predefined distribution policy and processing limitations, such as the number of people expected to work during a shift on a given day, the model modifies categorization results to mathematically smooth the peaks and valleys of workload fluctuations in business processes. The results are displayed on the user interface.

### BACKGROUND

The present invention relates generally to systems and methods for managing available resources applied to a discrete range of prioritized workflow categories or tasks in order to balance or level resource utilization in business processes. More particularly, the invention makes use of an analysis model for dynamic allocation of resources to prioritized work categories to smooth business processes work load fluctuations by altering data and modifying the prioritized workflow categories. The model relies on a specific time range or other specified data selection and predefined process limitations, such as the level of available resources.

In most business processes, ranging from healthcare to education to research, there exists a problem of effectively applying available resources to specific tasks or workflow categories that must be accomplished to satisfy goals. Specific task or work categories to be accomplished may be a project for a new product development in a company performing research and development, a production line for producing a multiplicity of products in a manufacturing company, or a call center that handles a plurality of media streams such as telephone calls, facsimile messages, electronic mail, web forms and video. Other examples include loan processing in banking institutions, claims processing in insurance companies, and order processing in a mail order company. In order to satisfy business goals by accomplishing these workflow categories, resources available to the business must be allocated based on workflow priorities, where the workflow usually involves coordination of multiple activities. These resources may be human resources having various skill sets, such as development and design personnel, production line assemblers and testers and call center agents, or the resources may be machinery or computer resources. There is a strong motivation in businesses for applying available resources to accomplishing business goals in an effective and optimized manner.

Many tools have been developed to address the problems associated with managing workflows and the application of resources thereto. Examples include the use of Gantt charts and project schedules, as well as more advanced computer-automated tools for applying resource management techniques to workflow problems. Many of these tools require the user to manually allocate resources to a workflow process. There is a need for a tool that can effectively allocate defined resources to workflow processes under constraints determined by the workflow environment and a user. A tool must be able to balance and level resource utilization in business processes in an optimized manner and provide dynamic category allocation of resources. Using predefined processing limitations, it must be capable of modifying categorization results to smooth peaks and valleys of workload fluctuations in the workflow process.

### SUMMARY

The present invention is directed to a resource management solution for balancing and leveling resource utilization in business processes, which provides dynamic category allocation of resources. The invention analyzes and alters categorization data within a user specified data limitation, such as a time range. It modifies categorization results to smooth peaks and valleys of workload fluctuations using predefined processing constraints, such as the resources available within the specified data limitation.

The disclosed resource management solution is a system and method for resource leveling and visualization comprising analysis model processing and a user interface. Both the user interface and server-issued requests can execute an analysis and resource balancing command. The analysis model processing includes automated resource balancing activities that performs resource leveling by analyzing categorization counts, and identifying and altering selected categorization data. Upon completion of the balancing process, altered categorization data is available for use by the business workflow process.

The user interface provides the capability to define an analysis model and to view resource statistics. The user interface provides capability for administration and monitoring the analysis model. The administration capability enables definition of the analysis model and related parameters. Only authorized users may access the administration application. Schedule support may define when resource balancing occurs. The monitoring capability enables definition of the process whereby an operator or end customer user may see current workloads and resource limits that are produced from the resource balancing process, typically in a graphical format.

An embodiment of the invention is a method for allocating resource utilization to categorized tasks in workflow processes comprising the steps of determining resource requirements for one or more prioritized task categories to be completed within a selected time period, each of the one or more prioritized task categories including a plurality of prioritized tasks, determining resource capability available within the selected time period, comparing the resource requirements with the resource capability for determining excess resource capability, resource capability overflow and equal resource capability, identifying a prioritized task category including a plurality of prioritized tasks to be adjusted for equalizing the resource capability and the resource requirements, and adjusting the number of prioritized tasks in the identified prioritized task category for equalizing the resource capability and the resource requirements. The step of adjusting may further comprise, for excess resource capability, adjusting the identified prioritized task category by adding one or more prioritized tasks to the identified prioritized task category for equalizing the resource capability and the resource requirements, and for resource capability overflow, adjusting the identified prioritized task category by subtracting one or more prioritized tasks from the prioritized task category for equalizing the resource capability and the resource requirements. The step of adjusting the identified prioritized task category for excess resource capability by adding one or more prioritized tasks to the identified prioritized task category may comprise re-categorizing tasks into the identified prioritized task category from a lower priority non-resourced task category.

The step of adjusting the identified prioritized task category for resource capability overflow by subtracting one or more prioritized tasks from the prioritized task category may comprise re-categorizing tasks into a lower priority non-resourced task category from the identified prioritized task category. The step of adjusting the identified prioritized task category for excess resource capability by adding one or more prioritized tasks to the identified prioritized task category may further comprises performing a database query to obtain a task document count of excess capability within the selected time period, calculating the number of task documents in the identified prioritized task category to change if the task document count is greater than zero, and updating the task documents by re-categorizing the task documents into the identified prioritized task category from a lower priority non-resourced task category. The step of calculating the number of task documents may comprise performing resource requirement summation calculations the highest priority task category count summed with each subsequent priority task category count, calculating deltas for each quantity summation calculation by dividing the resource capability available by each quantity summation calculation, sequentially analyzing the calculated deltas and stopping the analysis if a calculated delta is equal to one, indicating that resource requirements is equal to resource capability, sequentially analyzing the calculated deltas and stopping the analysis if a calculated delta is less than one, indicating that resource requirements is greater than resource capability, and calculating the number of documents to alter by subtracting resource capability from resource requirements. The step of adjusting the identified prioritized task category for resource capability overflow by subtracting one or more prioritized tasks from the prioritized task category may further comprise performing a database query and obtaining a task document count of capability overflow within the selected time period, calculating the number of task documents in the identified prioritized task category to change if the task document count is greater than zero, and updating the task documents by re-categorizing the task documents into a lower priority non-resourced task category from the identified prioritized task category. The step of calculating the number of task documents may comprise performing resource requirement summation calculations the highest priority task category count summed with each subsequent priority task category count, calculating deltas for each quantity summation calculation by dividing the resource capability available by each quantity summation calculation, sequentially analyzing the calculated deltas and stopping the analysis if a calculated delta is equal to one, indicating that resource requirements is equal to resource capability, sequentially analyzing the calculated deltas and stopping the analysis if a calculated delta is less than one, indicating that resource requirements is greater than resource capability, and calculating the number of documents to alter by subtracting resource requirements from resource capability. The step of adjusting may be determined by a distribution policy. The distribution policy may be contained in a data set that includes action to be taken for excess resource capability for each category, action to be taken for resource capability overflow for each category and a strategy for selecting records to change for each category.

Another embodiment of the present invention is a system for allocating resource utilization to categorized tasks in workflow processes comprising means for determining resource requirements for one or more prioritized task categories to be completed within a selected time period, each of the one or more prioritized task categories including a plurality of prioritized tasks, means for determining resource capability available within the selected time period, means for comparing the resource requirements with the resource capability for determining excess resource capability, resource capability overflow and equal resource capability, means for identifying a prioritized task category including a plurality of prioritized tasks to be adjusted for equalizing the resource capability and the resource requirements, and means for adjusting the number of prioritized tasks in the identified prioritized task category for equalizing the resource capability and the resource requirements. The means for comparing, identifying and adjusting may comprise an analysis model implemented on a computer system. The one or more prioritized task categories, the plurality of prioritized tasks, the resource capability and the selected time period may be contained in working datasets entered via a user interface, stored in a database, and accessed by the analysis model for allocating the resource capability to the plurality of categorized tasks. The datasets may comprise an input dataset, a configuration values dataset, an SQL command dataset and a command dataset. The means for adjusting may include a distribution policy. The distribution policy may be a dataset that includes action to be taken for excess resource capability for each category, action to be taken for resource capability overflow for each category and a strategy for selecting records to change for each category.

Yet another embodiment of the present invention is a method for allocating resource utilization to categorized tasks in workflow processes comprising the steps of determining resource requirements for one or more prioritized task categories containing a plurality of prioritized tasks to be completed within a selected time period, determining resource capability available within the selected time period, comparing the resource requirements with the resource capability for determining quantity of adjustment required for equalizing the resource capability and the resource requirements, identifying prioritized tasks within an identified prioritized task category to adjust according to a distribution policy, and adjusting the identified prioritized tasks according to the distribution policy. The method may further comprise the steps of entering the resource requirements, entering the selected time period, and entering the resource capability into a database via a user interface. The steps of comparing, identifying, and adjusting may be executed by a computer system using the resource requirements, the selected time period, the resource capability, and the distribution policy stored in the database. The method may further comprise the step of displaying the adjusted prioritized tasks on a user interface. The step of adjusting may comprise adding the prioritized tasks to the identified prioritized task category in an excess capability condition for equalizing the resource capability and the resource requirements. The step of adjusting may comprise subtracting the prioritized tasks from the identified prioritized task category in a resource capability overflow condition for equalizing the resource capability and the resource requirements. The distribution policy may be contained in a data set that includes action to be taken for excess resource capability for each category, action to be taken for resource capability overflow for each category and a strategy for selecting records to change for each category.

### BRIEF DESCRIPTION OF DRAWINGS

These and other features, aspects and advantages of the present invention will become better understood with regard to the following description, appended claims, and accompanying drawings wherein:

FIG. 1A illustrates possible variations in a resource-constrained process;

FIG. 1B depicts a flow diagram of a process embodiment of the invention;

FIG. 2 illustrates an example where three categories of interest exist, providing a contiguous range of categories and categorization scores;

FIG. 3 illustrates a situation of excess capability, where process capability can handle more than the document processing quantities;

FIG. 4 shows a case of insufficient capability or capability overflow, where process capability cannot handle the document processing quantities;

FIG. 5 shows calculations used to determine the deltas between capability and quantities of the categories of interest;

FIG. 6 defines three example categories used in the analysis model;

FIG. 7 illustrates the process flow of the analysis model;

FIG. 8 is a table that defines each processing step in the analysis model;

FIG. 9 defines quantity summation calculations used in the analysis model;

FIG. 10 defines delta calculations used in the analysis model;

FIG. 11 defines the definition of deltas used in the analysis model;

FIG. 12 defines the calculation to define the number of documents D_{N} to alter;

FIG. 13 illustrates the process flow with the data of the analysis model;

FIG. 14 is a table that defines each dataset in the analysis model;

FIG. 15 illustrates the Input Data dataset that defines the values that are provided as the model invocation values or parameters;

FIG. 16 is a table that names the Input Data dataset values and provides a description of each value;

FIG. 17 illustrates the SQL Commands dataset that contains the SQL commands used to identify and update the altered documents;

FIG. 18 is a table that names the SQL Commands dataset values and provides a description of each value;

FIG. 19 illustrates the Configuration Values that describes the configuration-specific values for an analysis model;

FIG. 20 is a table that names the Configuration Values dataset values and provides a description of each value;

FIG. 21 illustrates the Distribution Policy Settings values that define the categories to be selected for changing and how they are to be changed once an excess capability or capability overflow condition has been recognized;

FIG. 22 illustrates the Command Data dataset that contains invocation state data and copies of all the configuration and SQL command datasets; and

FIG. 23 is a table that names the Command Data dataset values and provides a description of each value name.

### DETAILED DESCRIPTION

The following terms are used in the detailed description of the invention:

| | |
|---|---|
| Analysis Model | a collection of values and steps that define the analysis- |
| | processing characteristics of a resource balancing |
| | execution in the system; |
| Capability | that amount of things that can be accomplished or done |
| | by some level of resources; |
| Category | a unique status assigned to data; |
| Category Score | numerical representation of relevance within a Category; |
| Classification | process of determining a Category; |
| Constraint | quantifiable limit or maximum value of a Resource; |
| Document | structured business information, existing in a database as |
| | a record; |
| Resource | altering classification data to provide a leveling effect |
| Balancing | on available resources; |
| Resource | the overall control and reporting of the flow of work in |
| Management | a resource-constrained business process; |
| Resource | a business object with limited availability and capability. |

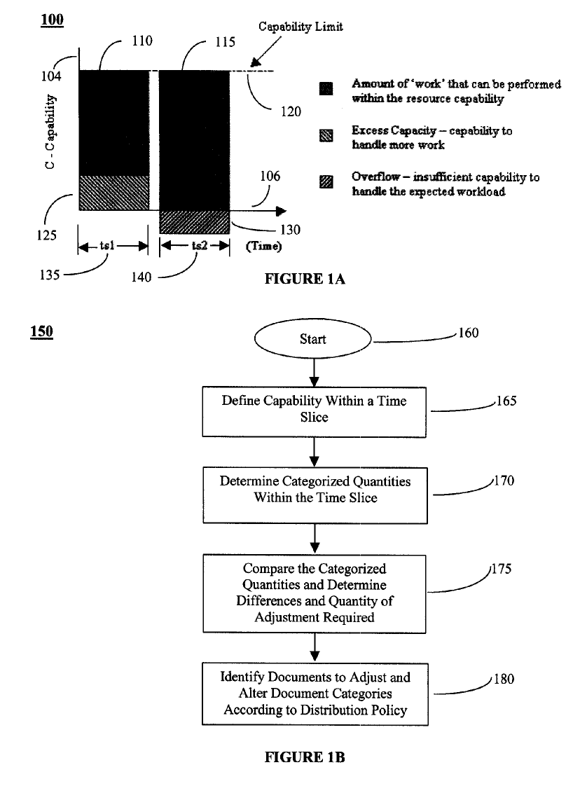

Turning to FIG. 1A, FIG. 1A illustrates possible variations in a resource-constrained process 100. Resource balancing occurs by analyzing and altering categorization data. A resource-constrained process has some pre-defined capability of interest, such as how many categorization documents can be processed in a period of time. This general concept is illustrated in FIG. 1A, which shows possible variations in a resource-constrained process. The vertical or Y-axis 104 represents capability, or the amount of things that can be accomplished or done by some level of resources. The capability limit 120 is shown as the maximum Y value (a varying limit would apply to longer time-period graphs). The horizontal or X-axis 106 represents time, where each column represents a single time slice as some block of time. The contents of this graph illustrate the amount of work or tasks to be done within a time slice per the resource limitations. Each time slice column represents a quantity or capability that is needed or available to perform the required work tasks. The solid sections 110, 115 identify the capability needed to handle the known quantity of work in that time period, such as a number of insurance claims to review or documents to process.

In terms of categorization data, the known quantity (Q) consists of all the combined individual categorization documents that will be handled in the business process. These documents may consist of varying categories. In an insurance claims example, the known quantity may consist of claims that require review and claims that are questionable (two different categories). This quantity is conceptually represented by a sorted list of categorically scored documents, from the highest-priority category and score at the top, to the lowest-priority category and lowest score at the bottom. Only those categorization documents of interest are considered.

Three conditions exist regarding the quantity (Q) in relation to the capability (C). First (and not shown) is where the quantity of work to be done exactly matches the capability (Q=C). In an ideal process, this is the desired resource utilization, and the objective of this system is to approach this balance. The second condition can be referred to as an Excess Capability condition, shown in the back-hatched area 125 of time slice 1 (ts1) 135. In time slice 1 135, the solid area 110 represents an amount of work that can be performed by available resources based on a limited amount of available work. The lower crosshatched area 125 of time slice 1 135 represents an excess capacity of available resources that could be handled if additional work were available. This area 125 represents the ability to accept more work than that which is available in the known quantity (Q). By adding more work to the quantity of existing work, the known quantity can approach the ideal capability (Q→C) or capacity limit 120. The primary goal of this application is to handle this scenario by trying to fill that capability void 125 with more work. The third condition can be referred to as Capability Overflow, shown in time slice 2 (ts2) 140 by the forward-hatched area 130 below the horizontal axis. In time slice 2 140, the solid area 115 represents an amount of work that can be performed by available resources based on an overflow amount of available work. The lower crosshatched area 130 of time slice 2 140 represents an overflow of work that cannot be handled because of insufficient capacity of available resources to handle the additional work 130. This overflow 130 represents the amount of capability needed to satisfy the known quantity of work. This overflow can be used to either calculate the amount of resources needed to support the quantity of work, or it serves as a cutoff point, at which resource objects below the horizontal axis are simply ignored by the process due to lack of time or resources.

Turning to FIG. 1B, FIG. 1B depicts a flow diagram 150 of a process embodiment of the invention. The primary objective of this solution is to identify either documents to alter to fill excess capability, represented by 125 in FIG. 1A, or documents to alter to eliminate capability overflow, represented by 130 in FIG. 1A, thus providing balanced process capabilities for known resource limitations. A secondary objective is to identify the resources needed to satisfy anticipated categorized quantities by analyzing capability overflow. To accomplish these objectives, the capability quantity (C) within a time frame (time slice) is compared with known category quantities (Q) in that same time frame. The overall process consists of defining a capability within a time slice 165, determining categorized quantities within the same time slice 170, comparing the categorized quantities and determining differences and quantity of adjustments needed 175, identifying documents to adjust, if any, and altering the categories of those documents according to a distribution policy 180. A distribution policy defines which categories can be adjusted to which other categories, depending on excess or overflow capability conditions.

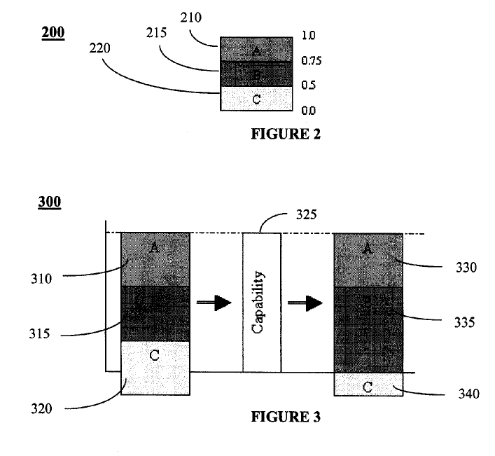

Turning to FIG. 2, FIG. 2 illustrates an example 200 where three categories of interest exist, providing a contiguous range of categories and categorization scores. FIG. 2 illustrates an example where three categories of documents of interest exist, providing a contiguous range of categorized documents and their relevant scores as shown. Category A documents 210 have scores from 1.0 to 0.75, category B documents 215 have scores from 0.75 to 0.5, and category C documents 220 have scores from 0.5 to 0.0.

Turning to FIG. 3, FIG. 3 illustrates a situation of excess capability 300, where process capability can handle more than the document processing quantities. FIG. 3 illustrates a category distribution of excess capability. In this example, documents consisting of three categories exist: A 310, B 315, and C 320. The capability has been defined, and the document distribution by category has been determined. The capability supports all of categories A 310 and B 315, and part of category C 320. In this process, only those documents in categories A 310 and B 315 are processed, and category C 320 documents are ignored. However, since the process has excess capability (A 310 and B 315 do not consume the entire capability), B 315 is expanded to fill the excess 335, using documents from category C 320. This is accomplished by changing the category of higher-scored documents in category C 320 to category B 335. The resulting changes in categorization provide the distribution as shown in the right side of the illustration 330, 335, 340. The documents previously categorized as C 320 that fall into the excess capability have been changed to category B 340.

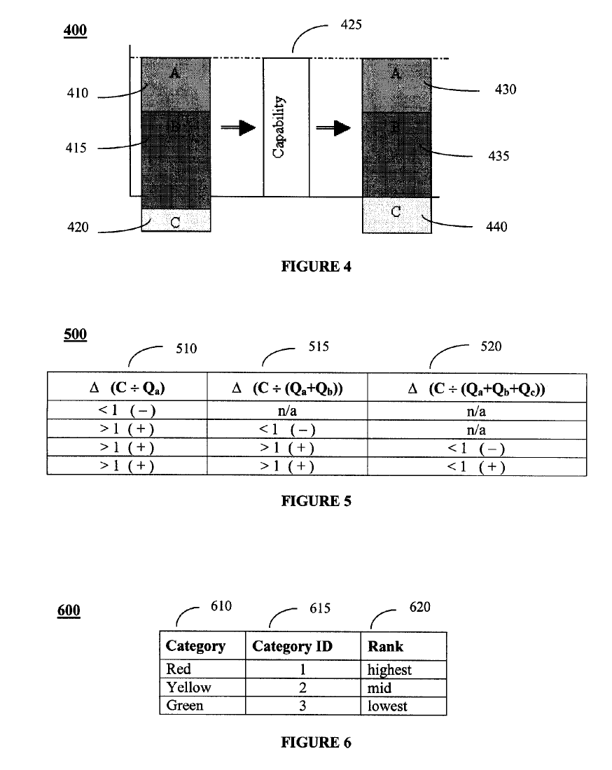

Turning to FIG. 4, FIG. 4 shows a case of insufficient capability or capability overflow 400, where process capability cannot handle the document processing quantities. FIG. 4 illustrates a category distribution of capability overflow. In this example, assume documents consisting of three categories exist: A 410, B 415, and C 420, and that category B 415 has a large number of occurrences. The capability has been defined, and the document distribution by category has been determined. The capability supports all of category A 410 but only part of category B 415, and no part of category C 420. In this process, only those documents in categories A 410 and B 415 are processed, and category C 420 documents are ignored. However, since the process can only handle some of the needed capability (A 410 and B 415 require more capability than available), B 415 must be reduced to an amount that can be handled; this is accomplished by changing the category of lower-scored documents in category B 415 to category C 420. The resulting changes in categorization provide the distribution as shown in the right side of the illustration 430, 435, 440. The documents previously categorized as B 415 that fall into the overflow capability have been changed to category C 440. Note that in this example, the overflow can be used to identify the extra capability needed so that all of category B 415 can be handled. Simply by taking the overflow amount and the normal capability, a delta representing the additional capability can be calculated, from which the resources needed to satisfy that capability may be determined.

In general, the calculations used for category distribution leveling make use of the following defined parameters:

| | |
|---|---|
| C | Capability quantity within a time slice, calculated |
| | from resources or provided as input; |
| | and |
| Qₓ | Quantity for a specific category within a time |
| | slice, where x is the category. |

In the above scenarios represented by FIG. 3 and FIG. 4, the following definitions are used for category distribution leveling:

| | |
|---|---|
| C | Capability quantity; |
| Qₐ | Quantity of category A documents; |
| Q_{b} | Quantity of category B documents; and |
| Q_{c} | Quantity of category C documents. |

Turning to FIG. 5, FIG. 5 shows calculations 500 used to determine the deltas between capability and quantities of the categories of interest. FIG. 5 is a table of calculations 500 that determine the deltas between capability and quantities of the categories of interest. The delta is calculated by dividing the capability by the accumulated quantities of categorized documents 510, 515, 520 until a delta of 1.0 or less is obtained, starting at the highest-priority category and including successively lower-priority categories. In this example, category A is highest priority, followed by category B, and category C is the lowest priority. Each resulting delta is compared to a value of 1.0. Delta values equal to 1.0 indicate an exact match of capability to quantity. Those values are not shown in the table of FIG. 5. Where the result is less than 1.0, represented by a minus sign (−), the quantity is more than the capability can handle, hence an overflow condition exists. Where the result is more than 1.0, represented by a plus sign (+)), the categorization quantity is less than the capability, resulting in an excess capability condition. Once an overflow capability condition is determined, other lower-priority categories can be ignored and are not applicable (n/a). The process involves calculating the possible points of excess or overflow. Where there is excess capability, the adjustments (as shown in FIG. 3) can be applied. Where there is capability overflow, the adjustments (as shown in FIG. 4) can be applied. Using these calculations, the number of documents to be altered (D_{N}) can be determined. The specific documents can then be obtained using the following example database SQL query. For simplicity, the time and date range typically used to define the analysis time slice have been omitted.

For excess capability condition, D_{N}=C−(Q_{A}+Q_{B}):

select doc_key from worklist where category=C order by category_score

desc fetch first D_{N} rows only.

The above query reads the document identifiers (doc_key) from a table named worklist, getting the D_{N} highest-scoring records within a category of C.

For capability overflow condition, D_{N}=(Q_{A}+Q_{B})−C:

select doc_key from worklist where category=B order by category_score

asc fetch first D_{N} rows only.

The above query reads the document identifiers (doc_key) from a table named worklist, getting the D_{N} lowest-scoring records within a category of B.

The set of documents obtained in the above queries are then each updated using one of the following commands. This creates the altered distribution that results in a balanced resource distribution.

For excess capability:

update worklist set category=B where doc_key=[document identifier]

For capability overflow:

update worklist set category=C where doc_key=[document identifier]

Turning to FIG. 6, FIG. 6 defines three example categories 600 used in the analysis model for resource balancing. The resource balancing analysis model performs resource management categorization adjustments by identification of capability overflow and excess capability conditions. This process is not specific to the example values such as color 610 and category 615. For descriptive purposes, assume a categorization process is used with three categories 610 red, yellow and green, as illustrated in FIG. 6. The rank 620 of these categories is also shown in FIG. 6. Assume the goal is to balance the sum quantity of red and yellow documents towards an optimum capability efficiency, adjusting green to yellow to utilize any excess capability or adjusting yellow to green to eliminate capability overflow.

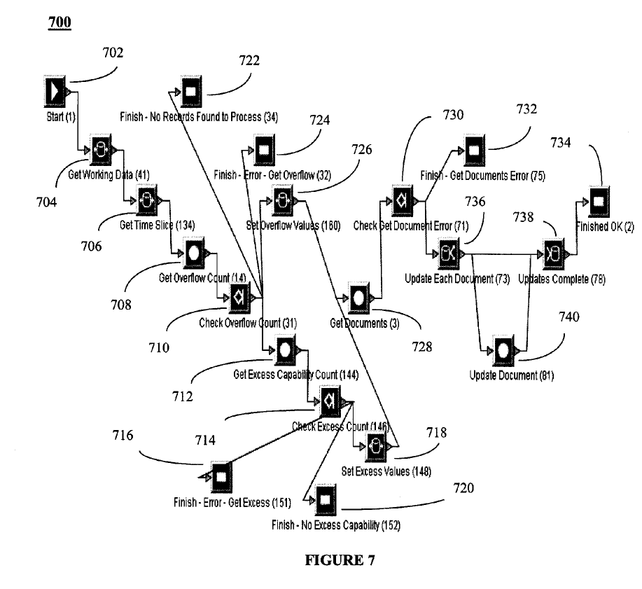

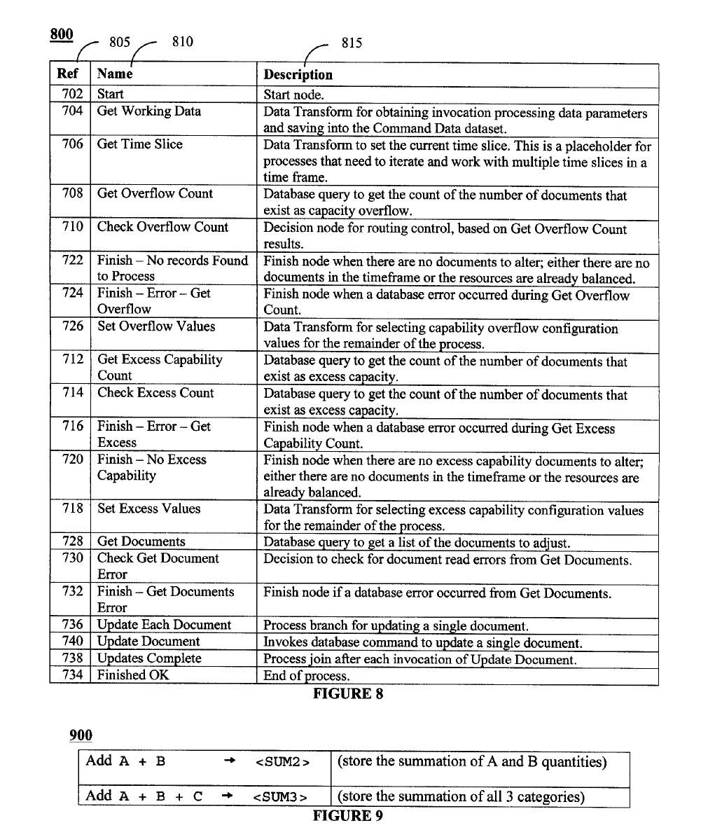

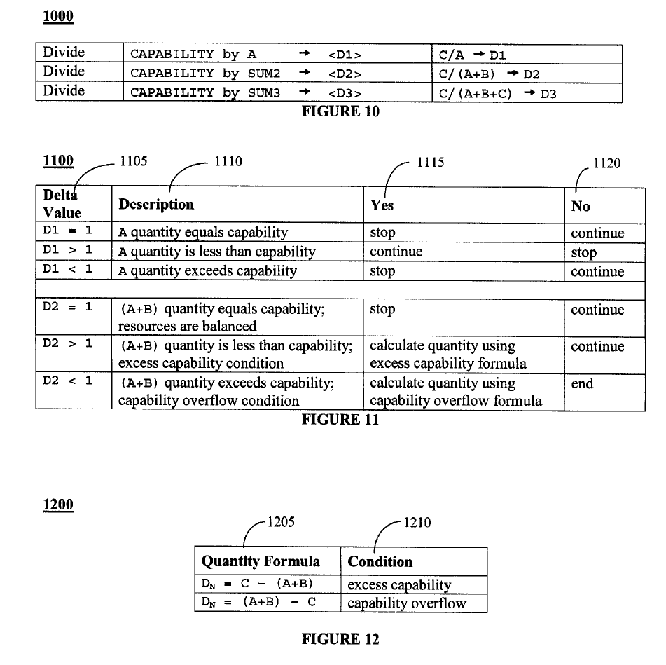

Turning to FIG. 7 and FIG. 8, FIG. 7 illustrates the process flow 700 of the analysis model. The process flow 700 of the analysis model is illustrated in FIG. 7. FIG. 8 is a table that describes each of the processing steps in the process flow 700 of the analysis model illustrated in FIG. 7. FIG. 8 describes reference numbers 805, names 810 and descriptions 815 of the processing steps shown in FIG. 7. The model consists of the following steps.
1. Initialize operational data. The process begins at Start 702. Initial data handling is performed with Get Working Data 704 and Get Time Slice 706. Get Time Slice 706 sets the date and time range used to identify and alter documents in the remaining Processing steps.
2. Calculate the number of documents in a specific category to change. The following steps are performed in steps 3 through 6.
   Perform quantity summation calculations shown in FIG. 9. FIG. 9 defines quantity summation calculations used in the analysis model. A combination of subsequent category counts is needed in the following.
   Calculate deltas as shown in FIG. 10. FIG. 10 defines delta calculations used in the analysis model.
   Analyze deltas as shown in FIG. 11. FIG. 11 defines the definition of deltas used in the analysis model. FIG. 11 includes delta values 1105, descriptions 1110, and whether the delta value is satisfied 1115 or not satisfied 1120.
   Calculate the number of documents D_{N} to alter as shown in FIG. 12. FIG. 12 defines the calculation to define the number of documents D_{N} to alter. It includes a quantity formula 1205 and a condition 1210.
3. Get Overflow Count 708 performs the database query to obtain the document count of possible capability overflow within the time range. A resulting count of greater than zero represents the number of documents of category yellow that can be adjusted to the green category.
4. Check Overflow Count 710 examines the resulting count and proceeds to one of the following steps.
   If the count is greater than zero, Set Overflow Values 726 is performed, followed by invocation of Get Documents 728.
   If the count is less than zero, Get Excess Capability Count 712 is performed.
   If the count is zero, Finish-No Records Found to Process 722 path is taken, ending the process; this means no documents to analyze were found in the time range.
   If a database error occurred, Finish-Error-Get Overflow 724 path is taken, ending the process.
5. Get Excess Capability Count 712 performs the database query to obtain the document count of possible excess capability within the time range. A resulting count of greater than zero represents the number of documents of category green that can be adjusted to the yellow category.
6. Check Excess Count 714 examines the resulting count and proceeds to one of the following steps.
   If the count is greater than zero, Set Excess Values 718 is performed, followed by invocation of Get Documents 728.
   If the count is zero, Finish-No Excess Capability 720 path is taken, ending the process. This means no documents to analyze were found in the time range.
   If a database error occurred, Finish-Error-Get Excess 716 path is taken, ending the process.
7. Get Documents 728 obtains the documents in the database within the specified time frame for modification. Check Document Read Error 730 examines the results and proceeds to one of the following steps:
   If a database error occurred, Finish-Document Read Error 732 path is taken, ending the process.
   If no database error occurred, Update Each Document 736 is performed. This step contains the identities of the specific documents that will be updated in the following steps. The purpose of the preceding process is to identify these specific documents. These documents comprise the set of documents that are being adjusted to meet the resource constraints.
8. Update Document 740 updates each of the documents by altering its category as determined in the preceding steps. If the documents represent capability overflow, their categories change from yellow to green; if the documents represent excess capability, then their categories change from green to yellow.
9. Updates Complete 738 is performed after all documents are updated, proceeding to Finished OK 734, completing the process.

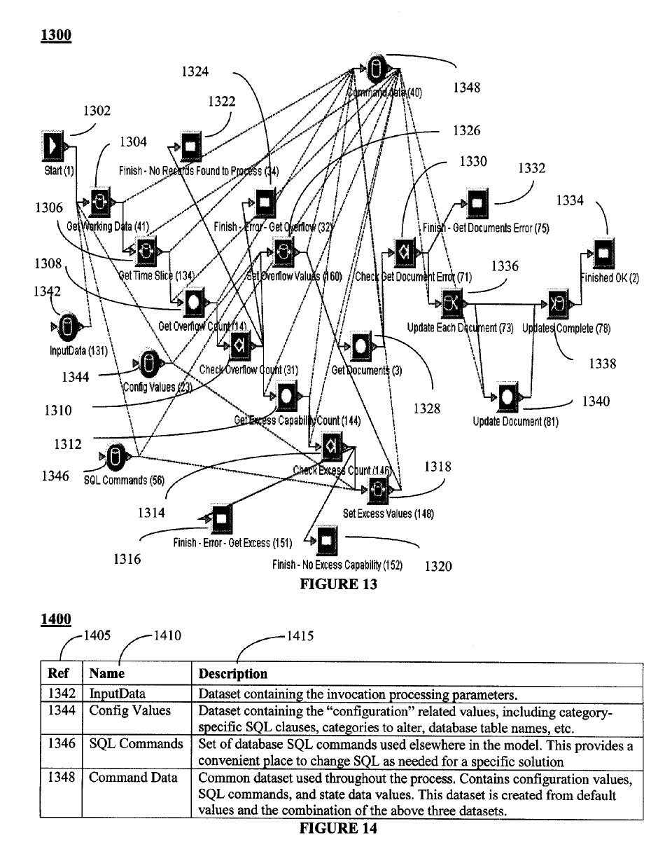

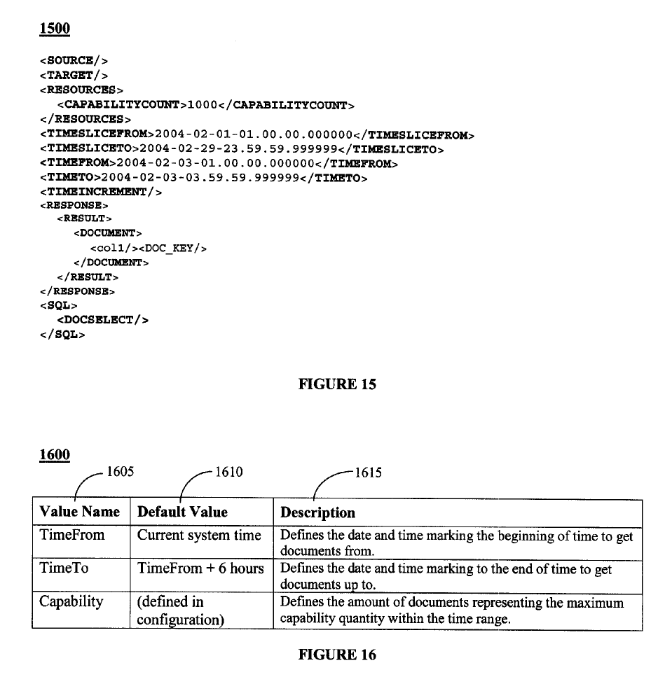

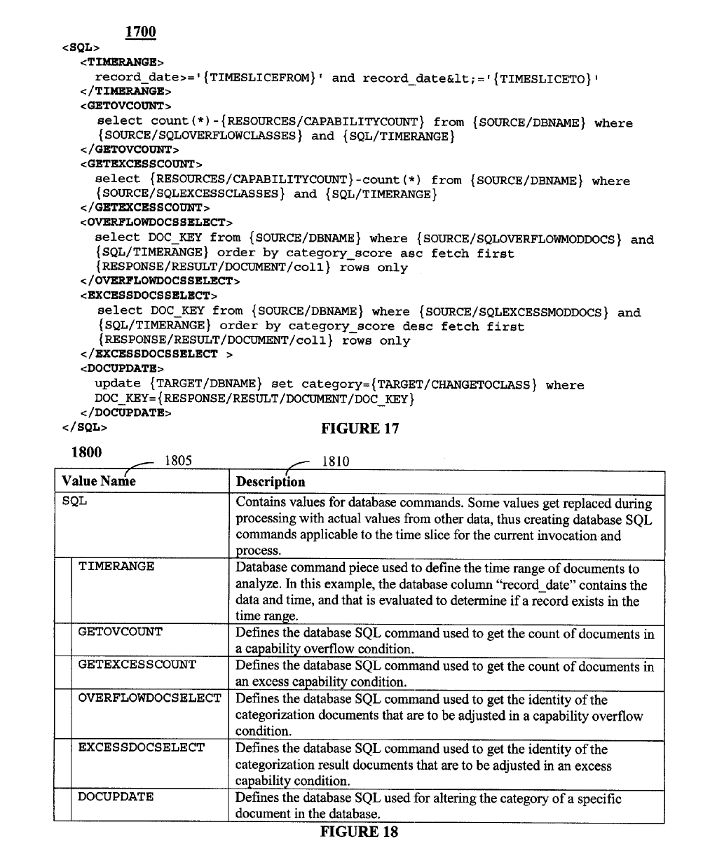

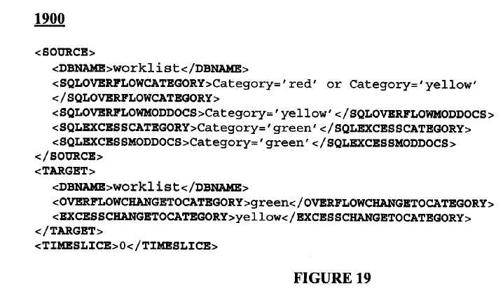

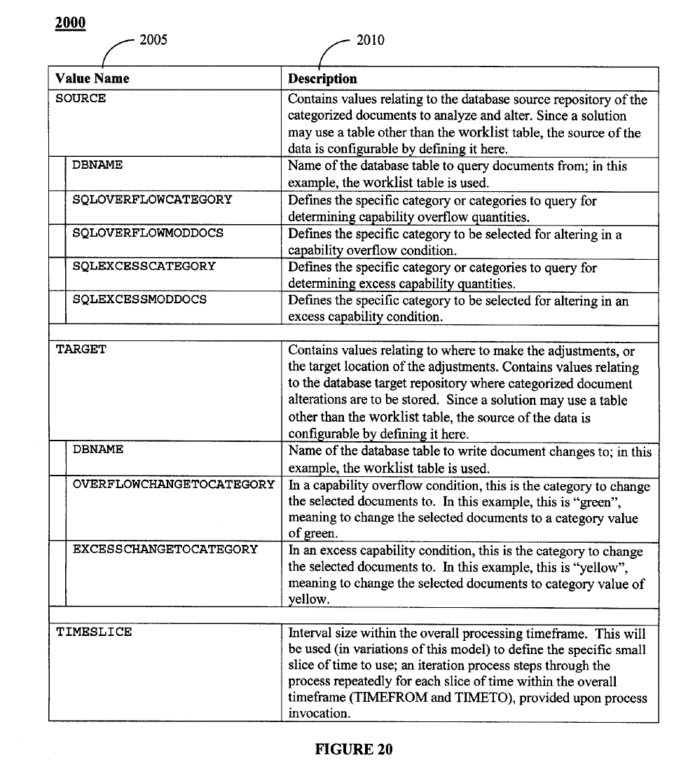

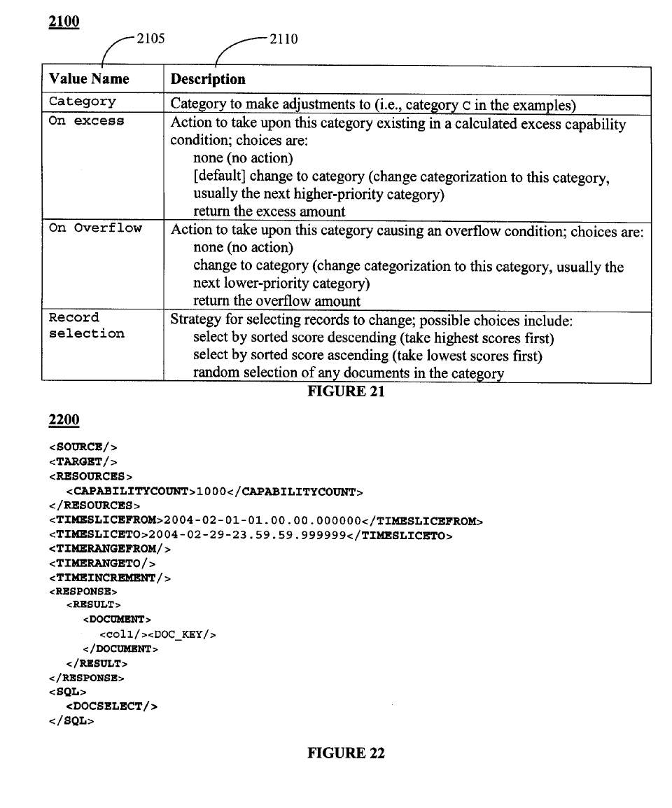

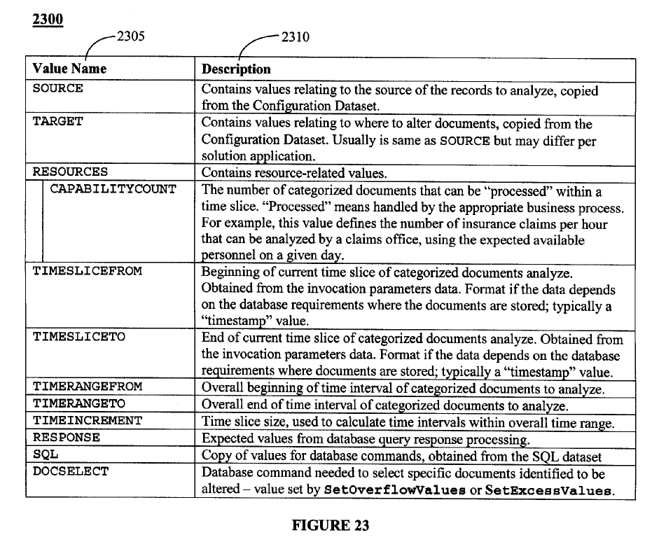

Turning to FIG. 13 and FIG. 14, FIG. 13 illustrates the process flow 1300 with the data of the analysis model shown in FIG. 7, and FIG. 14 is a table that defines each dataset in the analysis model. The processing steps 1302-1334 shown in FIG. 13 are identical to the processing steps 702-734, respectively, described and shown in FIG. 7 and FIG. 8 above. Lines connecting the described datasets to the steps of the analysis model indicate which datasets the steps of the model use. Data in the analysis model is contained in several datasets. FIG. 13 illustrates the model with the datasets, and FIG. 14 is a table that describes the values in the model datasets, including reference numbers 1405, names 1410 and description 1415. Several of the datasets contain values that can be modified to alter the operation and configuration of the model. In addition, values in some datasets contain references to other values. These values are replaced during processing with current state values. An Input Data 1342 dataset, shown in FIG. 15, contains invocation-processing parameters. FIG. 15 illustrates the Input Data dataset that defines the values that are provided as the model invocation values or parameters. FIG. 16 is a table that names the Input Data dataset values and provides a description of each value. FIG. 16 describes the invocation-specific value names 1605, default values 1610 and description 1615, which define the time range for documents to be analyzed and adjusted, and resource capability quantity. An SQL Commands 1346 dataset, shown in FIG. 17, contains the SQL commands used to identify and update the altered documents. FIG. 17 illustrates the SQL Commands dataset that contains the SQL commands used to identify and update the altered documents. They are defined in this dataset for ease of customization for a specific solution. FIG. 18 is a table that names the SQL Commands 1346 dataset values 1805 and provides a description of each value name 1810. A Configuration Values 1344 dataset, shown in FIG. 19, contains various configuration values that apply to the model and solution, and may be changed as needed to customize behavior. FIG. 19 illustrates the Configuration Values that describes the configuration-specific values for an analysis model. FIG. 20 is a table that names the Configuration Values 1344 dataset values 2005 and provides a description of each value name 2010. FIG. 21 defines the categories to be selected for changing and how they are to be changed once an excess capability or capability overflow condition has been recognized. FIG. 21 illustrates the Distribution Policy Settings values that define the categories to be selected for changing and how they are to be changed once an excess capability or capability overflow condition has been recognized. FIG. 21 includes value names 2105 and description 2110. Each category contains its own set of values, and is typically modified to fit a specific business solution. A Command Data 1348 dataset, shown in FIG. 22, contains current invocation state data. It also contains copies of all the configuration and SQL command datasets, so that all data is contained in a single dataset. FIG. 23 is a table that names the Command Data dataset values 2305 and provides a description of each value name 2310.

Although the present invention has been described in detail with reference to certain preferred embodiments, it should be apparent that modifications and adaptations to those embodiments might occur to persons skilled in the art without departing from the spirit and scope of the present invention.

What is claimed is:

1. A method for allocating resource utilization to categorized tasks in workflow processes, comprising the steps of:
determining resource requirements for one or more prioritized task categories to be completed within a selected time period, each of the one or more prioritized task categories including a plurality of prioritized tasks;
determining resource capability available within the selected time period;
comparing the resource requirements with the resource capability for determining excess resource capability, resource capability overflow and equal resource capability;
identifying a prioritized task category including a plurality of prioritized tasks to be adjusted for equalizing the resource capability and the resource requirements; and
adjusting the number of prioritized tasks in the identified prioritized task category for equalizing the resource capability and the resource requirements.

2. The method of claim 1, wherein the step of adjusting further comprises;
for excess resource capability, adjusting the identified prioritized task category by adding one or more prioritized tasks to the identified prioritized task category for equalizing the resource capability and the resource requirements; and
for resource capability overflow, adjusting the identified prioritized task category by subtracting one or more prioritized tasks from the prioritized task category for equalizing the resource capability and the resource requirements.

3. The method of claim 2, wherein the step of adjusting the identified prioritized task category for excess resource capability by adding one or more prioritized tasks to the identified prioritized task category comprises re-categorizing tasks into the identified prioritized task category from a lower priority non-resourced task category.

4. The method of claim 2, wherein the step of adjusting the identified prioritized task category for resource capability overflow by subtracting one or more prioritized tasks from the prioritized task category comprises re-categorizing tasks into a lower priority non-resourced task category from the identified prioritized task category.

5. The method of claim 2, wherein the step of adjusting the identified prioritized task category for excess resource capability by adding one or more prioritized tasks to the identified prioritized task category further comprises:
performing a database query to obtain a task document count of excess capability within the selected time period;
calculating the number of task documents in the identified prioritized task category to change if the task document count is greater than zero; and
updating the task documents by re-categorizing the task documents into the identified prioritized task category from a lower priority non-resourced task category.

6. The method of claim 5, wherein the step of calculating the number of task documents comprises:
performing resource requirement summation calculations the highest priority task category count summed with each subsequent priority task category count;
calculating deltas for each quantity summation calculation by dividing the resource capability available by each quantity summation calculation;
sequentially analyzing the calculated deltas and stopping the analysis if a calculated delta is equal to one, indicating that resource requirements is equal to resource capability;
sequentially analyzing the calculated deltas and stopping the analysis if a calculated delta is less than one, indicating that resource requirements is greater than resource capability; and
calculating the number of documents to alter by subtracting resource capability from resource requirements.

7. The method of claim 2, wherein the step of adjusting the identified prioritized task category for resource capability overflow by subtracting one or more prioritized tasks from the prioritized task category further comprises:
performing a database query and obtaining a task document count of capability overflow within the selected time period;
calculating the number of task documents in the identified prioritized task category to change if the task document count is greater than zero; and
updating the task documents by re-categorizing the task documents into a lower priority non-resourced task category from the identified prioritized task category.

8. The method of claim 7, wherein the step of calculating the number of task documents comprises:
performing resource requirement summation calculations the highest priority task category count summed with each subsequent priority task category count;
calculating deltas for each quantity summation calculation by dividing the resource capability available by each quantity summation calculation;
sequentially analyzing the calculated deltas and stopping the analysis if a calculated delta is equal to one, indicating that resource requirements is equal to resource capability;
sequentially analyzing the calculated deltas and stopping the analysis if a calculated delta is less than one, indicating that resource requirements is greater than resource capability; and
calculating the number of documents to alter by subtracting resource requirements from resource capability.

9. The method of claim 1, wherein the step of adjusting is determined by a distribution policy.

10. The method of claim 9 wherein the distribution policy is contained in a data set that includes action to be taken for excess resource capability for each category, action to be taken for resource capability overflow for each category and a strategy for selecting records to change for each category.

11. A system for allocating resource utilization to categorized tasks in workflow processes, comprising:
means for determining resource requirements for one or more prioritized task categories to be completed within a selected time period, each of the one or more prioritized task categories including a plurality of prioritized tasks;
means for determining resource capability available within the selected time period;
means for comparing the resource requirements with the resource capability for determining excess resource capability, resource capability overflow and equal resource capability;
means for identifying a prioritized task category including a plurality of prioritized tasks to be adjusted for equalizing the resource capability and the resource requirements; and
means for adjusting the number of prioritized tasks in the identified prioritized task category for equalizing the resource capability and the resource requirements.

12. The system of claim 11, wherein the means for comparing, identifying and adjusting comprises an analysis model implemented on a computer system.

13. The system of claim 12, wherein the one or more prioritized task categories, the plurality of prioritized tasks, the resource capability and the selected time period are contained in working datasets entered via a user interface, stored in a database, and accessed by the analysis model for allocating the resource capability to the plurality of categorized tasks.

14. The system of claim 13, wherein the datasets comprise an input dataset, a configuration values dataset, an SQL command dataset and a command dataset.

15. The system of claim 11, wherein the means for adjusting includes a distribution policy.

16. The system of claim 15, wherein the distribution policy is a dataset that includes action to be taken for excess resource capability for each category, action to be taken for resource capability overflow for each category and a strategy for selecting records to change for each category.

17. A method for allocating resource utilization to categorized tasks in workflow processes, comprising the steps of:
determining resource requirements for one or more prioritized task categories containing a plurality of prioritized tasks to be completed within a selected time period;
determining resource capability available within the selected time period;
comparing the resource requirements with the resource capability for determining quantity of adjustment required for equalizing the resource capability and the resource requirements;
identifying prioritized tasks within an identified prioritized task category to adjust according to a distribution policy; and
adjusting the identified prioritized tasks according to the distribution policy.

18. The method of claim 17, further comprising the steps of entering the resource requirements, entering the selected time period, and entering the resource capability into a database via a user interface.

19. The method of claim 18, wherein the steps of comparing, identifying, and adjusting are executed by a computer system using the resource requirements, the selected time period, the resource capability, and the distribution policy stored in the database.

20. The method of claim 17, further comprising the step of displaying the adjusted prioritized tasks on a user interface.

21. The method of claim 17, wherein the step of adjusting comprises adding the prioritized tasks to the identified prioritized task category in an excess capability condition for equalizing the resource capability and the resource requirements.

22. The method of claim 17, wherein the step of adjusting comprises subtracting the prioritized tasks from the identified prioritized task category in a resource capability overflow condition for equalizing the resource capability and the resource requirements.

23. The method of claim 17, wherein the distribution policy is contained in a data set that includes action to be taken for excess resource capability for each category, action to be taken for resource capability overflow for each category and a strategy for selecting records to change for each category.
